(19) United States
(12) Patent Application Publication
(10) Pub. No.: US 2014/0263020 A1
(43) Pub. Date: Sep. 18, 2014

(54) Refillable Liquid Filter Apparatus

(71) Applicant: Daniel MACDONALD, Toronto (CA)

(72) Inventor: Daniel MACDONALD, Toronto (CA)

(73) Assignee: Greenlife Water Corp., North York (CA)

(21) Appl. No.: 13/841,075

(22) Filed: Mar. 15, 2013

(51) Int. Cl. C02F 1/00; B65D 43/02

(52) U.S. Cl. CPC C02F 1/003; B65D 43/02
USPC 210/232; 220/200

(57) ABSTRACT

A removable lid for covering a chamber defined within a filter housing is described, wherein the removable lid includes a body having an upper portion and a lower portion, the upper portion having a larger perimeter than the lower portion, at least one inlet aperture formed on the body configured for liquid to flow therethrough to the chamber, and a coupling element positioned on the body configured to rotatably mount the removable lid to the filter housing.

### TECHNICAL FIELD

The following generally relates to a refillable liquid filter apparatus and parts for use in a refillable liquid filter apparatus.

### DESCRIPTION OF THE RELATED ART

Countertop water filter pitchers are commonly used in households to filter regular tap water. A typical countertop water filter assembly generally includes a reservoir for receiving unfiltered tap water, a filter cartridge containing filter media housed within the reservoir for filtering tap water, and a pitcher for receiving and storing filtered water. During a filtration process, unfiltered tap water passes through the filter media by the force of gravity. The filter media can be a highly porous material, such as activated charcoal, that removes various impurities such as chlorine and volatile organic compounds that may be present in unfiltered tap water. As a result of the filtration process, filtered water is produced and stored in the pitcher for consumption.

Since impurities are generally removed from unfiltered liquid through adsorption, it is necessary to replace the filter media after a certain number of filtration cycles for the filter apparatus to remain effective. However, replacing the filter media often requires replacing the entire filter cartridge that contains the filter media, since many of the cartridges sold on the market are disposable filter cartridges.

### BRIEF DESCRIPTION OF THE DRAWINGS

Example embodiments of the refillable liquid filter apparatus and parts for use in the same will now be described by way of example only with reference to the accompanying drawings in which:

FIG. 1 is a perspective view of an assembled filter apparatus.

FIG. 2A is an exploded view of the filter apparatus shown in FIG. 1.

FIG. 2B is an enlarged cut-away view of a receptacle.

FIG. 3 is a perspective view of a filter housing in an example embodiment.

FIG. 4 is a side view of the filter housing shown in FIG. 3.

FIG. 5 is a cross-sectional view of the filter housing taken at line I-I in FIG. 4.

FIG. 6 is a bottom view of the filter housing shown in FIG. 3.

FIG. 7 is a perspective view of a removable lid.

FIG. 8 is a side view of the removable lid shown in FIG. 7.

FIG. 9 is a top view of the removable lid shown in FIG. 7.

FIG. 10 is a perspective view of a removable lid having a gripping surface.

FIG. 11 is a perspective view of a removable lid having a hole formed therein.

FIG. 12 is a cross-sectional view of a hollow removable lid taken at line II-II in FIG. 11.

FIG. 13 is a bottom view of the hollow removable lid shown in FIG. 12.

FIG. 14 is a cross-sectional view of a solid removable lid taken at line II-II in FIG. 11.

FIG. 15 is a bottom view of the solid removable lid shown in FIG. 14.

FIG. 16 is a cross-sectional view of a filter apparatus including the removable lid shown in FIG. 14.

FIG. 17 is a perspective view of a removable lid having an outwardly flared profile.

FIG. 18 is a side view of the outwardly flared removable lid shown in FIG. 17.

FIG. 19 is a cross-sectional view of a filter apparatus including the removable lid shown in FIG. 17.

FIG. 20 is a perspective view of a removable lid having a tapered cylindrical body.

FIG. 21 is a cross-sectional view of the tapered cylindrical removable lid taken at line in FIG. 19.

FIG. 22 is a cross-sectional view of a filter apparatus including the removable lid shown in FIG. 20.

FIG. 23 is a perspective view of a removable lid having a skeletal structure.

FIG. 24 is a cross-sectional view of the skeletal removable lid taken at line IV-IV in FIG. 23.

FIG. 25 is a cross-sectional view of a filter apparatus including the removable lid shown in FIG. 23.

FIG. 26 is a perspective view of a removable lid having a tapered cylindrical body with a hole defined within the body.

FIG. 27 is a cross-sectional view of the removable lid taken at line V-V in FIG. 26.

FIG. 28 is a cross-sectional view of a filter apparatus including the lid shown in FIG. 26.

FIG. 29 is a perspective view of a removable lid having a recessed top surface with at least two ridges formed therein.

FIG. 30 is a cross-sectional view of the removable lid taken at line VI-VI in FIG. 29.

FIG. 31 is a perspective view of a removable lid having a recessed top surface with at least two arms extending upwardly and outwardly therefrom.

FIG. 32 is a cross-sectional view of the removable lid taken at line VII-VII in FIG. 31.

FIG. 33 is a cross-sectional view of a filter apparatus including the removable lid shown in FIG. 31.

FIG. 34 is a cut-away perspective view of a filter housing having an integrated feed reservoir.

FIG. 35 is a bottom view of the filter housing having an integrated feed reservoir as shown in FIG. 34.

FIG. 36 is a cross-sectional view of the filter housing having an integrated feed reservoir with the removable lid shown in FIG. 12 mounted therein.

FIG. 37 is a cross-sectional view of the filter housing having an integrated feed reservoir with the removable lid shown in FIG. 14 mounted therein.

FIG. 38 is a cross-sectional view of the filter housing having an integrated feed reservoir with the removable lid shown in FIG. 20 mounted therein.

FIG. 39 is a cross-sectional view of the filter housing having an integrated feed reservoir with the removable lid shown in FIG. 23 mounted therein.

FIG. 40 is a cross-sectional view of the filter housing having an integrated feed reservoir with the removable lid shown in FIG. 26 mounted therein.

FIG. 41 is a cross-sectional view of the filter housing having an integrated feed reservoir with the removable lid shown in FIG. 29 mounted therein.

FIG. 42 is a cross-sectional view of the filter housing having an integrated feed reservoir with the removable lid shown in FIG. 31 mounted therein.

FIG. 43 is a diagram of a user vertically manipulating a filter cartridge in an example embodiment.

FIG. 44 is a diagram of the user vertically manipulating the filter cartridge after the filter cartridge has been placed in a receptacle in an example embodiment.

FIG. 45 is a diagram view of the user rotating the removable lid of the filter cartridge after the filter cartridge has been placed in a receptacle in an example embodiment.

FIG. 46 is a diagram of the user removing the removable lid from the filter cartridge after the filter cartridge has been placed in a receptacle in an example embodiment.

FIG. 47 is a diagram of the user discarding spent filter media in an example embodiment.

FIG. 48 is a diagram of the user pouring new filter media into the filter housing in an example embodiment.

FIG. 49 is a diagram of the replenished filter cartridge housed within the filter apparatus in an example embodiment.

FIG. 50 is a cross-sectional view of the user rotatably mounting the removable lid to the filter housing once the filter cartridge has been replenished in an example embodiment.

FIG. 51 is an exploded cross-sectional view of a filter cartridge adapted to fit a sachet including filter media.

FIG. 52 is a partially exploded cross-sectional view of a filter cartridge adapted to fit the sachet including filter media.

FIG. 53 is an assembled cross-sectional view of a filter cartridge housing the sachet including filter media.

FIG. 54 is a cross-sectional perspective view of an assembled filter cartridge with a removable lid in an example embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Disposable filter cartridges are common for many countertop water filter pitchers used in many households. Typically, consumers buy expensive disposable filter cartridges that are specifically designed to fit their water filter pitcher each time the filter media needs to be replaced. Not only are disposable filter cartridges expensive and wasteful, but finding specific filter cartridges can be difficult for consumers, as retailers tend to only sell limited varieties of filter cartridges.

It is also recognized that disposable filter cartridges can also be problematic for manufacturers, distributors and retailers, since they tend to be bulky to ship and store, and expensive to manufacture. In particular, retailers generally have limited shelf space, and therefore can only accommodate limited quantities of filter cartridge.

It is also recognized that filter cartridges are shaped in such a way that a user may find it difficult to remove a filter cartridge from a filter pitcher. A substantial amount of pinch force is used in order for the user's fingers to grip onto the top of a filter cartridge.

It is also recognized that some filter cartridges can be refilled with filter media, but the process is time consuming and can include many steps. Further, removing a lid from a filter cartridge typically requires two hands. The process of refilling filter media can also be messy because the activated carbon granules can fall and disperse when emptying and refilling the filter cartridge.

Example embodiments of a filter apparatus and parts for use in the filter apparatus are described herein to address at least one of these issues.

An example embodiment of a filter apparatus in its assembled form is shown in FIG. 1. The filter apparatus generally includes a pitcher 1, a reservoir 10, a filter cartridge, and a top 3.

The pitcher 1 defines an open-top container for receiving and storing filtered liquid from the reservoir 10. The pitcher 1 includes a handle 2 for lifting the filter apparatus, and a spout 4 for pouring the filtered liquid. The open-top container defined by the pitcher 1 is also adapted to fit the reservoir 10, which houses the filter cartridge.

The reservoir 10 is adapted to receive liquid, for example water, and includes a receptacle 15 for fitting the filter cartridge. Other types of liquid can be filtered using the filter apparatus and parts described herein.

FIG. 2A shows an exploded view of the filter apparatus shown in FIG. 1 in an example embodiment. A portion of the reservoir 10 has been cut away to better show the receptacle 15. As shown in the figure, the filter module 20 includes a filter cartridge 30 defining a chamber and a removable lid 100 for covering the chamber defined by the filter cartridge 30. The reservoir 10 may further include a ribbed portion 11 for frictionally engaging a rim of the pitcher 1, and for fitting the top 3 to cover the reservoir 10.

FIG. 2B shows an enlarged cut-away view of the receptacle 15. The receptacle 15 is adapted to house a filter cartridge, such that filtered liquid may flow out of the filter cartridge to be received by the pitcher 1. In the figure, the receptacle 15 includes a protrusion 16 near or at the bottom of the receptacle 15 to fit a recessed portion 36 of the filter cartridge. The protrusion 16 is adapted to prevent the filter housing 30 from rotating while the recessed portion 36 is engaged by the protrusion 16. Although the protrusion 16 is shown as a symmetric U-shaped protrusion, the protrusion 16 may be shaped, sized, and configured in any manner that would prevent the rotation of the filter housing 30.

The pitcher 1, top 3, and reservoir 10 are examples only. It will be appreciated that the different embodiments described herein can apply to different types of pitchers, tops and reservoirs.

FIGS. 3-6 show an example embodiment of a filter cartridge 30. The term “filter housing” is sometimes used herein instead of “filter cartridge”. A filter cartridge is a specific embodiment of a filter housing that can be removed from the reservoir. A filter housing generally refers to any housing that defines a chamber 35 configured to hold filter media.

In the example embodiment shown in FIGS. 3-6, the filter housing 30 defines a chamber 35 for receiving filter media, and the filter housing 30 includes an engagement portion 34 near or at the top of the filter housing. The filter housing may further include a recessed portion 36 extending from the bottom of the housing and onto the sidewall, as well as a flange 32 formed near or at the top of the filter housing. The chamber 35 is generally adapted to receive porous granular filter media such as, for example, activated charcoal.

As show in FIG. 3, the engagement portion 34, for example, is a female thread formed near the opening of the chamber 35. The engagement portion 34 is generally adapted to rotatably mount a coupling element (e.g. a male thread or a protrusion) of the removable lid to sealably secure the removable lid to the filter housing 30. However, the position, orientation and the specific type of the engagement portion may vary in other embodiments. For example, the engagement portion may be a groove and a notch formed on the outer surface of the sidewall to provide a bayonet-type fit between the filter housing and the removable lid. In another example, the engagement portion 34 is a male thread positioned on the exterior surface of the filter housing's rim and the removable lid 100 includes a female engagement portion that is configured to surround engagement portion 34. In another example, the threads are not continuous. Different types of mechanical engagement suited for rotatably mounting the removable lid 100 can be used.

FIG. 4 shows a side view of the filter cartridge in the example embodiment shown in FIG. 3. The flange 32 in the example embodiment is an annular flange that extends out from the lip of the filter cartridge. The flange 32 generally acts to provide a liquid-tight seal between the filter cartridge and the reservoir, such that unfiltered liquid cannot reach the container defined by the pitcher 1 without passing through the filter media housed within the filter cartridge 30. Although the flange 32 is shown as being downwardly tapered, the flange 32 may take on other shapes and forms. Furthermore, the flange may further include additional sealing elements such as an o-ring to improve the seal between the filter housing and the reservoir, as well as between the filter cartridge and the removable lid.

Turning now to FIG. 5, a cross-sectional view of the filter cartridge taken at line I-I in FIG. 4 is shown. The filter cartridge 30 is shown as having a recess 36 that extends from the bottom surface to the sidewall of the filter cartridge 30. The recess 36 is U-shaped, and is generally positioned central to the filter cartridge 30. The recess 36 is adapted to engage a protrusion formed within the receptacle 15 of the reservoir 10 such that the filter cartridge 30 cannot rotate with respect to the reservoir 10 once the filter cartridge 30 is fitted within the receptacle 15 as will be illustrated later.

FIG. 6 is a bottom view of the filter cartridge 30, which shows an outlet aperture 40 being formed on the bottom surface 38 of the filter cartridge. The outlet aperture 40 is in fluid communication with the chamber defined by the filter cartridge, thus enable filtered liquid to flow out of the filter cartridge when in use. Although multiple square outlet apertures are illustrated in this example embodiment, the number of outlet apertures, as well as the size, shape and general configuration of each outlet aperture can vary in other embodiments. For example, the outlet aperture may be in form of narrow slits, and may additionally be formed on other portions of the bottom surface, such as in the recess 36. Additionally, the outlet aperture may be formed on or extend onto at least a portion of the sidewall to enable increased flow of liquid. In another example embodiment, there may also be a screen or fabric mesh that covers a larger sized aperture.

It will be appreciated that the removable lid is generally referenced by numeral 100. Different suffixes ‘a’, ‘b’, ‘c’, etc. are used to refer to different embodiments of the removable lid 100. It will also be appreciated that different features of the example embodiments of the removable lids, as described herein, may be combined with each other in different ways. In other words, a feature described with respect to one embodiment of a removable lid can be applied to another embodiment of a removable lid, although not specifically stated.

An example embodiment of a removable lid 100a is shown in FIGS. 7-9. As shown in the figures, the removable lid 100a generally has an upper portion 180a and a lower portion 182a, the upper portion 180a having a larger perimeter than the lower portion 182a. This particular example embodiment shows the removable lid 100a being frustoconical in shape, wherein the upper portion 180a of the removable lid is defined by a top surface 104, and the lower portion 182a is defined by a bottom surface 103 of the frustoconical body. Furthermore, the upper portion of the removable lid is connected to the lower portion with a circumferential surface 105, which is shown to be a continuous wall. The larger perimeter on the upper portion 180a of the removable lid reduces or eliminates the need for a user to apply a significant pinch force against the sides of the removable lid in order to lift the filter cartridge. In other words, the user is able to easily remove the filter cartridge even when the filter cartridge is wet or moist, since the user does not have to rely solely on friction to grasp on to the removable lid 100a. Additionally, the larger perimeter on the upper portion 180a of the lid enables the user to apply a greater torque to the engagement portion 102.

In other words, the upper portion 180a radially extends further out compared to the lower portion 182a.

As shown in FIG. 7, the removable lid 100a includes an inlet aperture 101 adapted to communicate unfiltered liquid (e.g. tap water) from the reservoir 10 into the chamber 35 defined by the filter housing 30 when in use, and a coupling element 102 formed on the bottom surface 103 of the frustoconical body for rotatably mounting the removable lid 100 to the filter housing.

FIG. 8 is a side view of the removable lid 100a shown in FIG. 7. In the figure, a coupling element 102 is shown as being a male thread in the illustrated embodiment. However, other coupling elements for rotatably mounting the removable lid to the filter housing may be used. Tapered threads, a bayonet-type engagement and discontinuous threads are non-limiting examples that can be used.

FIG. 9 is a top view of the removable lid 100a, which more clearly shows the inlet aperture 101. In this particular example embodiment, multiple radially arranged inlet apertures are shown, which assists in more evenly distributing the flow of liquid through the filter housing when in use. However, the inlet aperture may be sized, shaped, and configured in any manner that would enable unfiltered liquid to enter the filter cartridge during use. The number of inlet apertures may also vary. At least one inlet apertures is positioned on the lid 100a.

FIG. 10 shows an example embodiment of a removable lid 100b that includes a gripping surface 106 formed on the circumferential surface of the removable lid 100b. The presence of the gripping surface 106 enables the user to grip the surface more easily to effectively apply torque for tightening or loosening the removable lid 100b. The gripping surface 106 is especially useful when the removable lid 100b is still wet from recent use, and the liquid acts as a lubricant to reduce the friction between the user's fingers and the surface of the removable lid 100b. By providing a gripping surface 106, the user does not need to rely solely on friction to apply torque to the removable lid 100b, but rather, the user's fingers may engage the gripping surface 106 to more easily apply the necessary torque to the removable lid 100b. The gripping surface 106 can include ridges, or indents, or can include a surface with a high coefficient of friction, or combination thereof.

FIG. 11 shows an example embodiment of a removable lid 100c having a hole 107 formed on its circumferential surface 105 to act as an additional inlet for enabling liquid to flow into the filter housing when in use. In the example embodiment, multiple holes 107 are shown as being formed on the circumferential surface 105. The hole 107 is not only useful in creating additional back pressure within the filter cartridge during use, but the hole 107 also enables the reservoir to be completely drained of unfiltered liquid after every use, as will be shown later. In other embodiments, the circumferential surface 105 of the removable lid may further include a gripping surface.

FIG. 12 is a cross-sectional view of the removable lid 100c shown in FIG. 11 taken at line II-II. In this example embodiment, the body of the removable lid 100c defines a hollow space 108 therewithin. A bottom view of the same embodiment wherein the removable lid defines a hollow space is shown in FIG. 13. As shown in FIG. 12, the inlet aperture 101 extends only through the thickness of the top surface 104 of the removable lid 100. In particular, the inlet aperture 101 extends from top surface 104 to a bottom surface 184. This enables liquid to flow into the hollow space 108 defined by the body through the inlet aperture 101 and into the chamber of the filter housing during use. Similarly, the hole 107 formed on the circumferential surface 105 of the body only extends through the thickness of the circumferential surface 105 to connect to the hollow space 108. The hollow removable lid may be manufactured relatively easily and inexpensively using common techniques such as injection molding. Also, less material and processing is generally required to produce the removable lid shown in the example embodiment, since the interior is hollow and the inlet aperture as well as the hole only extends through the thickness of the respective surfaces.

FIGS. 14 and 15 show an example embodiment of a removable lid 100d having a “solid” interior. Inlet apertures 111, which define empty space, extend through the solid interior. In a cross-sectional view of the example embodiment as shown in FIG. 14, the inlet aperture 111 extends through the height of the removable lid 100d to enable unfiltered liquid to be communicated into the chamber of the filter housing when in use. In the example embodiment shown in FIG. 14, the hole 117 formed on the circumferential surface 115 connects to an inlet aperture. However, the hole 117 may alternatively extend inwardly and downwardly within the removable lid 100d to form a separate channel, independent from the inlet aperture 111, for communicating unfiltered liquid into the chamber when in use. The bottom view of the same example embodiment is shown in FIG. 15. The removable lid having a solid interior is particularly useful in controlling the flow rate and the pressure within the filter module, as well as for preventing loose filter media from escaping the filter cartridge. Furthermore, the removable lid having a solid interior may be used in some embodiments to compress the filter media against the interior wall of the housing to minimize the volume of gaps formed between filter media and the wall, as will be explained later.

FIG. 16 shows a cross-sectional view of a filter cartridge with a frustoconical removable lid 100d placed within the receptacle 15 of the reservoir 10. The filter cartridge is positioned within the receptacle 15, such that the recessed portion of the filter housing engages a protrusion 16 formed within the receptacle 15. This prevents the filter cartridge from rotating within the receptacle 15 while the protrusion 16 is engaged without hindering the removal of the filter cartridge from the receptacle 15.

As shown in FIG. 16, the frustoconical portion of the removable lid 100d is positioned above a bottom surface 17 of the reservoir 10, such that the user may hold or grip on to the frustoconical portion of the removable lid 100d in order to take the filter cartridge 30 out of the receptacle 15. In particular, the tapered side profile of the removable lid reduces or eliminates the need for a user to apply a significant pinch force against the sides of the removable lid in order to lift the filter cartridge. Rather, the filter cartridge may be removed by simply wrapping the user's fingers around a part of the frustoconical portion of the removable lid, and pulling the filter cartridge out while maintaining substantially the same distance between the fingers. Furthermore, since the removal of the filter cartridge requires less or no friction between the user's fingers and the surface of the removable lid, the user is able to easily remove the filter cartridge even when the filter cartridge is wet or moist.

The frustoconical portion also enables the user to tighten or loosen the removable lid with respect to the housing more easily, since the diameter taken at any horizontal plane within the frustoconical portion is greater than that of the coupling element 102. The larger diameter of the top portionenables the user to apply a greater torque to the coupling element, and therefore more easily tighten or loosen the removable lid from the filter housing.

FIGS. 17 and 18 show an example embodiment of a removable lid having an outwardly flared profile. In the perspective view shown in FIG. 17, the removable lid 100e is shown as having an inlet aperture 121 formed on its top surface 124 and a slit 127 formed on its circumferential surface 125. In this example embodiment, the upper portion 180e of the body is defined by the top surface 124, and the lower portion 182e is formed by the narrower bottom end of the flared body. The slit 127 achieves the same effects as the hole in the previous embodiment by enabling unfiltered liquid to be completely drained from the reservoir. In other words, liquid can pass through the slit 127. Additionally, the slit 127 may also be adapted to form a gripping surface for engaging the user's fingers. FIG. 18 is a side view of the removable lid 100e, and it shows the coupling element 122 being located at the bottom of the flared body.

FIG. 19 is a cross-sectional view of a filter cartridge having an outwardly flared removable lid 100e placed within the receptacle 15 of the reservoir 10. Similar to the embodiment shown in FIG. 16, the flared removable lid 100e defines a space 60 adapted to engage a user's fingers for easily lifting the filter cartridge while using reduced or no pinch force. Additionally, the flared removable lid 100e enables the user to apply a greater rotational force to the engagement portion whenever the removable lid 100e is rotated by grabbing the outwardly flared portion of the removable lid. This is due to the upper portion 180e of the body having a larger perimeter than the lower portion 182e of the body, thus enabling the user to achieve greater torque when turning the removable lid. Accordingly, the outwardly flared portion may further include a gripping surface formed on its exterior surface for engaging the user's fingers.

FIGS. 20 and 21 show an example embodiment of a removable lid 100f having a tapered cylindrical body. As shown in FIG. 20, the removable lid 100f includes a tapered wall 135 defining an open space 134 within, a hole 137 formed near or at the bottom of the tapered wall 135, and a gripping element 136 formed on the outer surface of the tapered wall 135. FIG. 21 is a cross-sectional view of the removable lid taken at line III-III in FIG. 20, and shows an inlet aperture 131 being formed through the bottom portion 139 of the removable lid 100f. In this example embodiment, unfiltered liquid may reach the inlet aperture 131 through the open space 134 defined by the tapered wall or through the hole 137 formed on the tapered wall. As shown in the perspective view in FIG. 20, the outer surface of the tapered cylindrical body includes the gripping element 136 formed thereon for engaging the user's fingers. The gripping element may, for example, encompass the entire outer surface of the tapered cylindrical body, or it may only encompass a portion of the outer surface at or near the top of the tapered cylindrical body. The upper portion 180f of the removable lid 100f is defined to be at or near the opening of the tapered cylindrical body, while the lower portion 182f is defined at or near the coupling element 132.

FIG. 22 is a cross-sectional view of a filter cartridge having a removable lid 100f with a tapered cylindrical body placed within the receptacle 15 of the reservoir 10. The tapered cylindrical body provides the same advantages described previously for the embodiment shown in FIG. 16. The tapered cylindrical body also generally requires less material to form, and since the inlet aperture 131 only extends through the coupling element 132, it may be also be easier to manufacture. Although the coupling element is shown in FIG. 22 as having the same diameter as the narrowest part of the tapered cylindrical body, in another example embodiment, the coupling element 132 may have a smaller diameter than the narrowest part of the tapered cylindrical body to further increase the torque that can be applied to the coupling element by the user.

FIGS. 23 and 24 show an example embodiment of a removable lid 100g having a tapered skeletal structure. FIG. 23 is a perspective view of the removable lid 100g, and FIG. 24 is a cross-sectional view of the removable lid 100g taken at line IV-IV in FIG. 23. The removable lid 100g includes an upper portion 180g being supported above a lower portion 182g by struts, and a coupling element 142 attached to the base of struts. In this example embodiment, the upper portion 180g is shown as an annular support member 143, the lower portion 182g is the portion of the removable lid including the coupling element 142 and struts are shown as plurality of slanted support members 145 connecting the annular support member 143 to the lower portion 182g. The coupling element 142 further includes an inlet aperture 141 extending through the height of the coupling element 142 as shown in FIG. 24. In an example embodiment, a gap 147 formed between the adjacent slanted support members 145 is sufficiently large to accommodate at least a portion of the user's finger.

FIG. 25 is a cross-sectional view of a filter cartridge having a removable lid 100g with a tapered skeletal structure placed within the receptacle 15 of the reservoir 10. As previously stated, the gap 147 formed between the adjacent slanted support members 145 may be sufficiently large to accommodate at least a portion of the user's finger such that the user's finger may engage the annular support member 143 when lifting the filter cartridge, or it may engage the sides of the slanted support members 145 when rotating the removable lid 100g. This enables the user to more easily apply rotational force to the removable lid 100g, since the user does not need to rely on the friction between the user's fingers and the removable lid 100g when lifting or rotating the removable lid 100g. Additionally, no significant pinch force or less pinch force is required to lift and remove the filter cartridge 30 from the receptacle 15 of the reservoir 10. The user, for example, positions their fingers under a portion of the annular support member 143 and maintains the relative finger spacing when importing a lifting force to lift the filter cartridge. Furthermore, the tapered skeletal structure enables greater torque to be applied to the coupling element by the user when the user holds removable lid 100g near or at the top of the vertical support members, since the upper portion 180g has a larger perimeter than the lower portion 182g.

FIGS. 26 and 27 show an example embodiment of a removable lid 100h having a tapered cylindrical body 155 with a hole or a space 157 formed therein for fitting at least a portion of the user's fingers. As illustrated in the figures, the hole 157 may be arch-shaped, for example. In this example embodiment, the upper portion 180h is defined at or near a lip 154 of the tapered cylindrical body, while the lower portion 182h is defined by a coupling element 152. As shown in the figures, the tapered cylindrical body is joined to the coupling element 152 at its bottom end, and an inlet aperture 151 is formed on the coupling element 152 to enable unfiltered liquid to enter the filter cartridge when in use. As shown in FIG. 27, which is a cross-sectional view of the removable lid 100h taken at line V-V in FIG. 26, the inlet aperture 151 extends through the height of the coupling element 152.

In another example embodiment, not showing the hole 157 is much smaller than as illustrated and the tapered cylindrical body 155 further includes indents that are sized to receive at least a portion of a user's finger.

FIG. 28 is a cross-sectional view of a filter cartridge having a removable lid 100h with a tapered cylindrical body with a space formed therein and the filter cartridge 100h being placed within the receptacle 15 of the reservoir 10. As previously stated, the hole 157 formed on the tapered cylindrical body is adapted to fit at least a portion of the user's finger such that the top of the hole may engage the user's finger when the filter cartridge is being lifted, and the sides of the hole may engage the user's finger while the removable lid 100h is being rotated.

FIGS. 29 and 30 show an example embodiment of a removable lid 100i having a recessed top surface and at least two ridges formed on the recessed top surface. As shown in FIG. 29, the recessed top surface 164 includes an inlet aperture 161 extending from the recessed top surface to the bottom surface 169 of a coupling element 162 for enabling unfiltered liquid to flow into the chamber of the filter housing during use. The recessed or lowered surface funnels liquid from the reservoir 10 into the inlet aperture 161. As shown in the figure, there may be additional inlet apertures formed on the recessed top surface to enable greater flow. The recessed surface is also shown as having at least two ridges 166a, 166b positioned at the perimeter of the recessed top surface to engage the user's fingers for rotatably mounting or removing the removable lid 100i. The ridges 166a, 166b are spaced apart from each other to form a gap 167. The presence of the gap directs the user's fingers toward the ridges 166a, 166b whenever the user wishes to mount or remove the removable lid 100i. Since the ridges 166a, 166b are positioned at or near the perimeter of the recessed surface, engaging the ridges 166a, 166b encourages the user to apply greater torque to the removable lid 100i compared to gripping a surface near the middle of the lid. As shown in FIG. 30, which is a cross-sectional view of the removable lid 100i taken at line VI-VI in FIG. 29, the coupling element 162 may encompass the entire height of the circumferential surface of the removable lid, or alternatively, the coupling element 162 may only cover a portion of the circumferential surface. The inlet aperture 161 extending through the removable lid 100i between the recessed surface 164 and the bottom surface 169 is shown using dotted lines for illustrative purposes. Although not shown in the figures, the removable lid may include any additional number of ridges in any suitable orientation and configuration.

FIGS. 31 and 32 show an example embodiment of a removable lid 100j having at least two arms 176a, 176b projecting upwardly and outwardly from a recessed top surface 174. FIG. 31 is a perspective view of the example embodiment, and FIG. 32 is a cross-sectional view of the removable lid 100j taken at line VII-VII in FIG. 31. As shown in FIG. 31, the recessed top surface 174 include an inlet aperture 171 extending therethrough to the bottom of the fastening portion 172, and the inlet aperture 171 is shown for illustrative purposes in FIG. 32 with dotted lines. In an example embodiment, the arms 176a, 176b extend upwardly and outwardly from the ridges shown in the embodiment illustrated in FIGS. 29 and 30. For example, the arms 176a, 176b may be formed integrally with the ridges and the body of the removable lid 100j. As shown in the figures, the arms 176a, 176b may extend past the perimeter of the recessed surface 174 and the body to enable the removable lid 100j to be rotated with greater torque. Furthermore, the removable lid may include any number of additional arms, and the arms may be spaced apart from one another by a gap 177 as illustrated in the figures.

FIG. 33 is a cross-sectional view of a filter cartridge having a removable lid 100j with at least two arms 176a, 176b being placed in a receptacle 15 of a reservoir 10. As shown in the figure, the arms 176a, 176b is generally adapted to engage the user's fingers at the bottom of the arms and at the sides of the arms. For example, the user's fingers may engage the bottom of the arms in order to remove the filter cartridge from the receptacle 15 of the reservoir 10 when in use, or the user's fingers may engage the opposing sides of the opposing arms to rotatably mount or remove the removable lid 100j from the filter housing. Since the arms 176a, 176b extend beyond the coupling element 172 of the removable lid 100j, the user is able to apply greater rotational force to the coupling element 172.

Although not shown in the figures, the removable lid described in any of the embodiments above may optionally include a screen for preventing filter media from leaving the chamber. The screen may be a woven or non-woven screen member, and may be made of materials such as plastic, metal, cotton, or paper, for example.

FIGS. 34 and 35 show an example embodiment of a filter housing, wherein the filter housing further includes a portion which extends outwardly and upwardly from the lip of the chamber defined by the filter housing to integrally form a feed reservoir for receiving and storing unfiltered liquid. In other words, the filter housing and the feed reservoir are integrated. In an example embodiment, the filter housing and the feed reservoir form a unitary piece.

In a cut-away perspective view of an integrated filter housing apparatus 31 shown in FIG. 34, the filter housing 30 is integrated with feed reservoir 42. In an example embodiment, the integrated filter housing apparatus is manufactured to be a unitary piece. The filter housing 30 defines a chamber 35 for receiving filter media and an engagement portion 34 formed therein. The integrated feed reservoir 42 may further include a ribbed portion 44 near or at the lip for engaging the pitcher and the top. The engagement portion 34 is formed near or at the lip of the chamber 35, and the engagement portion 34 is adapted to rotatably mount a removable lid. Furthermore, the bottom surface 45 of the integrated feed reservoir in an example embodiment is slanted downwards towards the opening of the chamber 35 to assist filter media in entering the chamber 35 when the filter housing is replenished by the user. This configuration reduces the mess caused when refilling filter media. The downwardly tapered bottom surface may also assist the liquid contained within the feed reservoir 42 to flow toward the removable lid to be filtered during use. It can be appreciated that the integrated filter housing apparatus 31 does not require a filter cartridge.

FIG. 35 shows a bottom view of the filter housing having an integrated feed reservoir 42. The bottom surface 38 of the filter housing includes an outlet aperture 40 extending through the bottom surface to enable filtered liquid to flow out of the chamber. Although not shown in the figures, a filter mesh may also be positioned on the interior or the exterior surface of the bottom wall, or both, to prevent filter media housed inside the chamber from escaping through the outlet aperture. The filter mesh may be identical in construction to the screen used in the removable lid, for example.

FIGS. 36-42 show cross-sectional views of the integrated filter housing apparatus 31 being fitted with various example embodiments of the removable lid. The filter housing 30 is shown as containing filter media 80 in all the figures. In particular, FIG. 36 shows the filter housing 30 being fitted with a hollow frustoconical removable lid 100c, FIG. 37 shows the filter housing 30 being fitted with a solid frustoconical removable lid 100d, FIG. 38 shows the filter housing 30 being fitted with a removable lid 100f having a tapered cylindrical body, FIG. 39 shows the filter housing 30 being fitted with a removable lid 100g having a skeletal structure, and FIG. 40 shows the filter housing 30 being fitted with a removable lid 100h having a tapered cylindrical body with a hole or an indent formed therein.

FIG. 41 shows the filter housing being fitted with a removable lid 100i having a recessed top surface and at least two ridges formed therein. As previously mentioned, the ridges 166a, 166b may be spaced apart to form a gap 167 for directing the user's fingers toward the distal ends of the ridges 166a, 166b when rotating the removable lid 100i. This causes the user to apply rotational force to the removable lid 100i at points that are the furthest away from the center of the removable lid, thus enabling the torque applied to the removable lid 100i to be maximized.

Similarly, FIG. 42 shows the filter housing being fitted with a removable lid 100j having a recessed top and at least two arms projecting upwardly and outwardly from the recessed top surface. Since the arms 176a, 176b extend beyond the width of the coupling element 172, the arms 176a, 176b enable the user to apply an even greater torque to the removable lid 100j than if the user grips the removable lid 100j closer to the middle of the lid.

FIGS. 43-50 illustrate example steps for replenishing the filter module by discarding spent filter media and filling the filter cartridge with new filter media in one example embodiment. Only the steps for replenishing the filter module in form of the filter cartridge is shown in the figures, however, similar steps apply to replenishing the integrated filter housing apparatus 31.

FIG. 43 shows the user inserting the filter cartridge inside the receptacle located within the reservoir. The receptacle 15 includes a protrusion 16 adapted to engage the recessed portion 36 of the filter housing 30 such that the filter housing 30 is held in a specific orientation and cannot be rotated with respect to the reservoir 10 and the pitcher 1.

After the filter cartridge is placed inside the receptacle 15 as shown in FIG. 44, at least a portion of the removable lid 100 sits above a level defined by the bottom surface 17 of the reservoir such that the user may manipulate the filter cartridge by engaging the removable lid 100. As shown in FIGS. 45 and 46, once the filter cartridge is held in one orientation by the engagement between the protrusion 16 and the recessed portion 36, the removable lid 100 may be rotatably removed by applying rotational force. A user can use one hand to rotate the removable lid. And since the filter cartridge does not turn, the removable lid will screw off the filter cartridge; this is achieved with one hand. Advantageously, the filter cartridge does not even need to be removed from the receptacle and can remain in the receptacle when emptying and refilling filter media. This reduces the number of steps to refill the filter media.

Since the removable lid may be rotatably removed from the filter cartridge without first taking the filter cartridge out of the receptacle, the user may refill the filter cartridge using only one hand as will be shown.

FIG. 47 shows the user discarding spent filter media after the removable lid has been removed. As shown in the figure, the user may simply grab the handle 2 of the pitcher 1 housing the reservoir 10 and the filter housing 30 to discard spent filter media 80a contained within the chamber of the filter housing 30 by turning the pitcher 1 such that the opening of the chamber faces down.

Although not shown in the figures for simplicity, the filter apparatus may further include additional elements for preventing the reservoir and the filter housing from falling out of the pitcher when the apparatus is turned upside down. In another example embodiment, the friction fit between the flange of the filter housing and the receptacle may be sufficient in retaining the filter housing, and similarly, the friction fit between the ribbed portion of the reservoir and the pitcher may be sufficient in preventing the reservoir from falling out when discarding spent filter media.

FIG. 48 shows the user pouring new filter media 80b into the reservoir 10 and the filter housing 30 after the filter housing 30 has been emptied of spent media. As shown in the figures, the bottom surface 17 of the reservoir 10 may be angled downwardly to assist in funneling new filter media 80b toward the opening of the chamber defined by the filter housing 30. After a sufficient amount of new filter media 80b has been dispensed, the user may lightly shake the pitcher 1 to ensure all new filter media 80b have entered the chamber.

After filling the filter housing 30 with new filter media 80a, the removable lid 100 may be rotatably mounted on the filter housing 30 to cover the chamber as shown in FIGS. 49 and 50. This can be achieved with one hand.

By enabling the user to replenish the filter module with new filter media 80a while the filter housing 30 is still positioned within the receptacle 15, the number of steps that a user takes in order to replenish the filter module is reduced compared to other methods of replenishing a filter module which require the user to first remove the filter module from the receptacle. Furthermore, it has been recognized that removing the filter module from the receptacle prior to replenishing the filter housing often results in waste of new filter media when the user attempts to pour new filter media into the filter housing. Waste is created, for example, due to the poured filter media not being captured by the opening of the filter housing, as well as loss of filter media due to over-pouring of the media by the user. By enabling the user to pour new filter media into the filter housing while the filter housing is positioned within the receptacle, the chance of filter media falling outside the opening is reduced due to the larger opening of the receptacle, and even if the filter media is over-poured, excess filter media is contained by the receptacle, allowing the user to scoop excess filter media back into the source.

In another example embodiment, the user may remove the filter cartridge containing the spent filter media from the receptacle, replenish the filter module with new filter media while the filter housing is outside the reservoir, and then place the filter cartridge containing new filter media back in the receptacle for use.

FIG. 51 shows an example embodiment of a filter cartridge wherein the filter housing is adapted to receive a sachet 84, which includes a liquid-permeable membrane 82 enclosing filter media 80. The liquid-permeable membrane 82 may be woven or non-woven membrane, and may be made of materials such as plastic, cotton or paper fiber, for example. Additionally, the liquid-permeable membrane 82 may be constructed from a single continuous member or may be constructed by joining two or more members together in any manner. The liquid-permeable membrane 82 is generally porous to enable liquid to pass through the membrane such that liquid may be filtered by coming in contact with filter media 80 housed within.

In the example embodiment shown in FIG. 51, the volume of the sachet 84 is larger than the volume of the chamber 35 defined by the filter housing 30 when the sachet is in an uncompressed state. The ability for the sachet to be compressed as well as having a larger volume than the chamber 35 in its uncompressed state helps to reduce the volume of any gaps that may be present when the sachet is loaded in the filter cartridge. Gaps, especially those formed between the wall of the chamber 35 and the filter media 80, can reduce the effectiveness of the filter cartridge, since unfiltered liquid can pass through the gaps and, thus, through the filter cartridge without contacting filter media.

FIG. 52 shows the sachet 84 being placed within the filter housing 30 during an initial loading stage. As shown in the figure, gaps 62 are formed between the liquid-permeable membrane 82 and the wall of the chamber 35. Since the sachet 84 has not been fully compressed at the initial loading stage, a portion of the sachet is shown as extending beyond the opening of the chamber 35. Although not shown in the figure, there may also be additional gaps formed among filter media or between filter media and the liquid-permeable membrane.

During the loading stage of the filter cartridge, the removable lid is rotatably mounted to cover the chamber housing the sachet. In order to begin rotatably mounting the removable lid, the user may press the removable lid against the portion of the sachet extending beyond the opening of the chamber. By pressing on the removable lid, the sachet becomes slightly compressed, reducing or eliminating some of the gaps formed within the filter housing. After the removable lid is in contact with the engagement portion of the filter housing, the removable lid may be rotatably mounted. As the removable lid is rotated with respect to the filter housing, the bottom surface of the removable lid travels deeper into the opening, further compressing the sachet until the sachet reaches a compressed state where the sachet occupies substantially the same volume as the chamber. This results in the volume of gaps being reduced after the removable lid has been fully mounted to the filter housing, as shown in FIG. 53.

Although not shown, the sachet 84 can also be used with the integrated filter housing apparatus 31.

The combination of the compressible sachet and rotatably mounted removable lid is particularly useful in minimizing the total volume of gap formed within the loaded filter housing, since it only requires little compressive force, if any, to be generated by the user at the beginning in order for the fastening portion of the removable lid to engage the filter housing. After the fastening portion of the removable lid has engaged the filter housing, it is relatively easy for the user to rotate the removable top to further eliminate the gaps formed within the filter cartridge. Furthermore, the tightening or the loosening of the removable lid may be facilitated even further by using various example embodiments of the removable lid as previously described.

The use of sachet may be particularly advantageous for manufacturers, distributors, and retailers, since the sachet may be packaged to only take up a minimal amount of space. This enables the manufacturers and distributors to ship and store larger quantities of filter media compared to disposable filter cartridges for a given amount of shipping or storage space, and furthermore, the use of shelf space at retailers is optimized since the sachet may take up substantially less space compared to disposable filter cartridges.

The refillable liquid filter apparatus and parts for use in a refillable liquid filter apparatus may be marketed and sold in various forms. For example, a kit of parts including a removable lid according to any of the embodiments previously described and a filter housing may be packaged and sold to be assembled by customers. The kit of parts for forming a filter module may be sold after the removable lid has already been rotatably mounted onto the filter housing, or the kit of parts may be sold in a partially or completely disassembled form. In an example embodiment, the kit of parts for forming a filter module may further include a sachet containing filter media. The kit of parts may be packaged such that the sachet is housed within the filter cartridge in its assembled form, or the sachet may be housed within the filter housing with the removable lid dismounted from the filter housing. Alternatively, the filter housing, the sachet, and the removable lid may be sold together in a partially or completely disassembled form. A kit of parts for forming a filter module may further include at least any one of a pitcher, a reservoir and a top for covering the reservoir. In another example embodiment, the filter sachet may be individually packaged in a separate packaging material and sold as part of the kit. For example, the packaging material of the filter sachet may be impermeable to air, enabling the manufacturer to maintain a relatively constant level of moisture within the packaging until the packaging is opened by the user. Additionally, the volume of the sachet may be larger than the volume of the chamber defined by the filter housing in the sachet's uncompressed state as described previously.

Turning to FIG. 54, another example embodiment of a filter module 20 is shown, including a filter housing 30 and a removable lid 100k assembled together. This cross-sectional view of the filter module 20 shows how the removable lid 100k and the housing 30 fit. It is noted that the filter media is not shown in this cross-sectional view to better show the features.

The upper portion of the removable lid 100k includes a number of holes 200 to facilitate the flow of liquid into the filter housing 30. The lower portion of the removable lid 100k includes retainers 192 (e.g. screw threads) to rotatably attach the removable lid to the filter housing 30.

The lid 100k has a side wall 198 that is positioned above a lower side wall 194, where the diameter of the lower wall 194 is smaller than the diameter of the wall 198. The lower wall 198 is positioned within the filter housing 30 and is in spaced relation to an upper wall 208 of the filter housing 30. The upper wall 208 includes holes 206 to facilitate the flow of water into the filter housing 30. A void or space 204 is at least defined between the upper wall 208 of the housing 30 and the lower wall 194 of the lid 100k. The lower wall 194 also a number of holes 196 for facilitating the flow of liquid into the filter housing 30.

In an example operation or use, water flows through the holes 206 and into the void or space 204. Water in the space 204 then flows through the holes 196 into the chamber defined by the filter housing 30. Water in the chamber of the filter housing can exit, for example, after being filtered, through the holes 210 located on the bottom of the filter housing 30.

General example embodiments will now be described, including example aspects of such embodiments.

In a general embodiment, a removable lid for covering a chamber defined within a filter housing includes a body comprising an upper portion and a lower portion, the upper portion having a larger perimeter than the lower portion, at least one inlet aperture formed on the body configured for liquid to flow therethrough to the chamber, and a coupling element positioned on the body configured to rotatably mount the removable lid to the filter housing.

In an aspect, the body is a frustoconical body.

In another aspect, the removable lid further includes a gripping element positioned on the external surface of the body.

In another aspect, the body further includes a top surface and a bottom surface, and the inlet aperture extends from the top surface to the bottom surface.

In another aspect, a hollow space is defined within the body.

In another aspect, the upper portion is supported above the lower portion with a continuous wall.

In another aspect, the upper portion is supported above the lower portion with a wall including at least one of an indent and a hole defined by the wall adapted to receive at least a portion of a user's finger.

In another aspect, the upper portion is supported above the lower portion with struts.

In another general aspect, a refillable filter module includes a filter housing having an opening, and at least one outlet aperture configured for liquid to flow therethrough, and the filter housing defining therein a chamber configured to receive filter media, a removable lid for covering the chamber, the removable lid including a body comprising an upper portion and a lower portion, the upper portion having a larger perimeter than the lower portion, at least one inlet aperture formed on the body configured for liquid to flow therethrough to the chamber, and a coupling element positioned on the body configured to rotatably mount the removable lid to the filter housing.

In an aspect, the refillable filter module is a refillable filter cartridge and further includes a recess formed on the filter housing, the recess being adapted to fit a protrusion formed on a reservoir to prevent the refillable filter cartridge from rotating.

In another aspect, the filter housing further includes a portion extending at least outwardly and upwardly from the opening to define a feed reservoir for receiving unfiltered liquid.

In another aspect, the chamber defined by the filter housing is adapted to receive a sachet, the sachet including filter media enclosed within a liquid-permeable membrane, and wherein the volume of the sachet is larger than the volume of the chamber when the sachet is in an uncompressed state.

In another aspect, the body is a frustoconical body.

In another aspect, the removable lid further includes a gripping element positioned on the external surface of the body.

In another aspect, the body further includes a top surface and a bottom surface, and the inlet aperture extend from the top surface to the bottom surface.

In another aspect, a hollow space is defined within the body.

In another aspect, the upper portion is supported above the lower portion with a continuous wall.

In another aspect, the upper portion is supported above the lower portion with a wall including at least one of a hole or an indent adapted to receive at least a portion of a user's finger.

In another aspect, the upper portion is supported above the lower portion with struts.

In another general aspect, a kit of parts that, when assembled, forms a refillable filter module includes a filter housing including an opening, and at least one outlet aperture configured for liquid to flow therethrough, and the filter housing defining therein a chamber configured to receive filter media, a removable lid for covering the chamber, the removable lid including a body comprising an upper portion and a lower portion, the upper portion having a larger perimeter than the lower portion, at least one inlet aperture formed on the body configured for liquid to flow therethrough to the chamber; and a coupling element positioned on the body configured to rotatably mount the removable lid to the filter housing.

In an aspect, the refillable filter module is a refillable filter cartridge and further includess a recess formed on the filter housing, the recess being adapted to fit a protrusion formed on a feed reservoir to prevent the refillable filter cartridge from rotating.

In another aspect, the filter housing further includes a portion extending at least outwardly and upwardly from the opening to define a feed reservoir for receiving unfiltered liquid.

In another aspect, the kit of parts further includes a sachet, the sachet including filter media enclosed within a liquid-permeable membrane, and wherein the volume of the sachet is larger than the volume of the chamber when the sachet is in an uncompressed state.

In another aspect, the body is a frustoconical body.

In another aspect, the kit of parts further includes a gripping element positioned on the external surface of the body.

In another aspect, the body further includes a top surface and a bottom surface, and the inlet aperture extends from the top surface to the bottom surface.

In another aspect, a hollow space is defined within the body.

In another aspect, the upper portion is supported above the lower portion with a continuous wall.

In another aspect, the upper portion is supported above the lower portion with a wall comprising a at least one of an indent or a hole adapted to receive at least a portion of a user's finger.

In another aspect, the upper portion is supported above the lower portion with struts.

In another general embodiment, a removable lid for covering an open chamber defined within a filter housing includes a body defining a recessed top surface, the recessed top surface having at least one inlet aperture configured for liquid to flow therethrough, at least two ridges positioned at the perimeter of the recessed top surface, the ridges being spaced apart from one another to define a gap therebetween, and a coupling element positioned on the body configured to rotatably mount the removable lid to the filter housing.

In an aspect, the ridges further include an arm extending upwardly and outwardly in a direction away from the gap.

In a further aspect, the arm extends past the perimeter of the body.

In another general embodiment, a refillable filter module including a filter housing having an opening and at least one outlet aperture configured for liquid to flow therethrough, the filter housing defining therein a chamber configured to receive filter media, a removable lid for covering the chamber, the removable lid having a body defining a recessed top surface, the recessed top surface including at least one inlet aperture configured for liquid to flow therethrough, at least two ridges positioned at the perimeter of the recessed top surface, the ridges being spaced apart from one another to define a gap therebetween, and a coupling element positioned on the body configured to rotatably mount the removable lid to the filter housing.

In an aspect, the ridges further include an arm extending upwardly and outwardly in a direction away from the gap.

In a further aspect, the arm extends past the perimeter of the body.

In another general aspect, a kit of parts is described that, when assembled, forms a refillable filter module, the kit of parts including a filter housing having an opening and at least one outlet aperture configured for liquid to flow therethrough, and the filter housing defining therein a chamber configured to receive filter media, a removable lid for covering the chamber, the removable lid having a body defining a recessed top surface, the recessed top surface including at least one inlet aperture configured for liquid to flow therethrough and at least two ridges positioned at the perimeter of the recessed top surface, the ridges being spaced apart from one another to define a gap therebetween, and a coupling element positioned on the body configured to rotatably mount the removable lid to the filter housing.

In an aspect, the ridges further include an arm extending upwardly and outwardly in a direction away from the gap.

In a further aspect, the arm extends past the perimeter of the body.

It will be appreciated that the particular example embodiments shown in the figures and described above are for illustrative purposes only and many other variations can be used according to the example embodiments described herein. Although the above has been described with reference to specific example embodiments, various modifications thereof will be apparent to those skilled in the art as outlined in the appended claims.

1. A removable lid for covering a chamber defined within a filter housing, the removable lid comprising:
a body comprising an upper portion and a lower portion, the upper portion having a larger perimeter than the lower portion;
at least one inlet aperture formed on the body configured for liquid to flow therethrough to the chamber; and
a coupling element positioned on the body configured to rotatably mount the removable lid to the filter housing.

2. The removable lid of claim 1, wherein the body is a frustoconical body.

3. The removable lid of claim 1, further comprising a gripping element positioned on the external surface of the body.

4. The removable lid of claim 1, wherein the body further comprises a top surface and a bottom surface, and the inlet aperture extends from the top surface to the bottom surface.

5. The removable lid of claim 1, wherein a hollow space is defined within the body.

6. The removable lid of claim 1, wherein the upper portion is supported above the lower portion with a continuous wall.

7. The removable lid of claim 1, wherein the upper portion is supported above the lower portion with a wall comprising at least one of an indent and a hole defined by the wall adapted to receive at least a portion of a user's finger.

8. The removable lid of claim 1, wherein the upper portion is supported above the lower portion with struts.

9. A refillable filter module comprising:
a filter housing comprising:
an opening; and
at least one outlet aperture configured for liquid to flow therethrough,
and the filter housing defining therein a chamber configured to receive filter media;
a removable lid for covering the chamber, the removable lid comprising:
a body comprising an upper portion and a lower portion, the upper portion having a larger perimeter than the lower portion;
at least one inlet aperture formed on the body configured for liquid to flow therethrough to the chamber; and
a coupling element positioned on the body configured to rotatably mount the removable lid to the filter housing.

10. The refillable filter module of claim 9, wherein the refillable filter module is a refillable filter cartridge and further comprises a recess formed on the filter housing.

11. The refillable filter module of claim 9, wherein the filter housing further comprises a portion extending at least outwardly and upwardly from the opening to define a feed reservoir for receiving unfiltered liquid.

12. The refillable filter module of claim 9, wherein the chamber defined by the filter housing is adapted to receive a sachet, the sachet comprising filter media enclosed within a liquid-permeable membrane, and wherein the volume of the sachet is larger than the volume of the chamber when the sachet is in an uncompressed state.

13. The removable lid of claim 9, wherein the body is a frustoconical body.

14. The removable lid of claim 9, further comprising a gripping element positioned on the external surface of the body.

15. The removable lid of claim 9, wherein the body further comprises a top surface and a bottom surface, and the inlet aperture extends from the top surface to the bottom surface.

16. The removable lid of claim 9, wherein a hollow space is defined within the body.

17. The removable lid of claim 9, wherein the upper portion is supported above the lower portion with a continuous wall.

18. The removable lid of claim 9, wherein the upper portion is supported above the lower portion with a wall comprising at least one of an indent and a hole defined by the wall adapted to receive at least a portion of a user's finger.

19. The removable lid of claim 9, wherein the upper portion is supported above the lower portion with struts.

20. A kit of parts that, when assembled, forms a refillable filter module, the kit of parts comprising:
a filter housing comprising:
an opening; and
at least one outlet aperture configured for liquid to flow therethrough, and the filter housing defining therein a chamber configured to receive filter media;
a removable lid for covering the chamber, the removable lid comprising:
a body comprising an upper portion and a lower portion, the upper portion having a larger perimeter than the lower portion;
at least one inlet aperture formed on the body configured for liquid to flow therethrough to the chamber; and
a coupling element positioned on the body configured to rotatably mount the removable lid to the filter housing.

21. The kit of parts of claim 21, further comprising a sachet, the sachet comprising filter media enclosed within a liquid-permeable membrane, and wherein the volume of the sachet is larger than the volume of the chamber when the sachet is in an uncompressed state.
